(19) United States
(12) Patent Application Publication
(10) Pub. No.: US 2009/0230199 A1
(43) Pub. Date: Sep. 17, 2009

(54) DIFFRACTIVE DATA STORAGE

(75) Inventor: John M. Bove, San Carlos, CA (US)

Correspondence Address: SCHNECK & SCHNECK, P.O. BOX 2-E, SAN JOSE, CA, 95109-0005, US

(73) Assignee: LASERCARD CORPORATION, Mountain View, CA (US)

(21) Appl. No.: 12/189,390

(22) Filed: Aug. 11, 2008

Related U.S. Application Data
(60) Provisional application No. 61/036,008, filed on Mar. 12, 2008.

(51) Int. Cl. G06K 19/06

(52) U.S. Cl. 235/494

(57) ABSTRACT

An identification card and a method for formation of the card are disclosed. The identification card comprises an optical identification element formed upon a surface of the identification card and an optical stripe formed on the optical identification element and having at least a portion formed substantially from a single material. The single material is configured to have a diffractive pattern formed thereon by exposure to a laser. The diffractive pattern is capable of retaining information that is, for example, unique to a cardholder and being readable by a light source external to the identification card.

### CROSS-REFERENCE TO RELATED APPLICATION

This application claims priority from U.S. Provisional Patent Application Ser. No. 61/036,008 entitled “Authentication for a Data Card,” filed Mar. 12, 2008 which is hereby incorporated by reference in its entirety.

### TECHNICAL FIELD

The present invention relates generally to portable identity or transactional data storage cards, and more particularly, to producing secure data on the card through a computer-assisted diffractive or holographic writing process.

### BACKGROUND

Wireless electronic identification devices, such as radio frequency identification device (RFID) cards, are known in the art. RFID cards frequently include a unique serial number permanently and unalterably burned into an integrated circuit contained within the card. The integrated circuit typically has sufficient memory capacity for data (e.g., stored electronically) such as a card issuer identification (ID) number, user information (name, account number, signature image, etc.), the private key of a public-private key pair, a digital signature, and a personal identification number (PIN).

Optical storage techniques may also be used with RFID cards. Optionally, optical storage techniques may be used separately as a primary or sole data storage means on an identification card. Such storage techniques are known in the art and utilize, for example, diffractive or holographic patterns embedded on the card. A common “rainbow transmission” hologram utilizes common white light (as opposed to monochromatic sources, such as lasers) as an illumination source on secured transaction cards (e.g., credit cards). The rainbow transmission hologram is fabricated as a surface relief pattern formed on a first side of a plastic film. A second side of the film is placed in contact with a reflective coating, such as a sputtered aluminum film region, which reflects light incident on the transmissive hologram thus allowing viewing from the first (i.e., front) side of the card. The holograms are commonly used as a security feature on a variety of transaction and identification cards.

With reference to FIG. 1, a prior art identification card 100 includes an optically encoded stripe 101 holding, for example, user data. An enlarged section 103 of the optically encoded stripe 101 reveals a diffraction grating-based optical identification element 105. The diffraction grating-based optical identification element 105 is comprised of an optical substrate 107, an optical diffraction grating 109 formed over the optical substrate, and a protective top layer 111. The optical diffraction grating 109 is frequently formed by photolithographic techniques known in the semiconductor fabrication art and is produced either over an uppermost surface or within a volume of the optical substrate 107.

The optical diffraction grating 109 is a periodic or aperiodic variation in the effective refractive index or effective optical absorption over at least a portion of the optical substrate 107. A change in the effective refractive index or effective optical absorption produces diffractive elements. Diffractive elements are known in the optical arts. The optical diffraction grating 109 thus serves to either reflect or refract light in a certain way to produce diffracted patterns of light. The diffracted patterns may be observed optically or read with a specialized diffracted light viewer, described below.

The optical diffraction grating 109 is frequently a photosensitive layer (e.g., such as photoresist) allowing patterning of the diffractive elements. The optical diffraction grating 109 may also be a hologram, as the diffraction grating 109 can transform, translate, or filter an optical input signal to produce a predetermined desired optical output pattern or signal. The use of holograms on identification and security transaction cards (e.g., credit cards) is well-known in the art.

Referring now to FIG. 2, a specialized diffracted light viewer 200 is used for inspection of data contained on the prior art identification card 100. The specialized diffracted light viewer 200 includes an incoming laser beam 201A incident upon the diffraction grating-based optical identification element 105, and an optical diffraction detector 203. The optical diffraction detector 203 includes an optional biconvex collection lens element 205 and a charge-coupled device (CCD) detection element 207. When the laser beam 201A is incident on the diffraction grating-based optical identification element 105, a plurality of diffracted light beams 201B is produced. The plurality of diffracted light beams 201B is collected either by the optional biconvex collection lens element 205 focusing the diffracted light beams 201B onto the CCD detection element 207, or onto the CCD detection element 207 directly. As shown in FIG. 2 for clarity, the specialized diffracted light viewer 200 is being used in a transmission mode. However, the specialized diffracted light viewer 200 may be used in reflected light mode as well by selecting an optical substrate 107 (FIG. 1) that is reflective.

The CCD detection element 207 reads an optical signal contained within the plurality of diffracted light beams 201B and determines a code based on diffractive elements present or the optical pattern produced. The CCD detection element 207 may be coupled to a computer (not shown) that verifies all information stored on the diffraction grating-based optical identification element 105. Alternatively, the CCD detection element 207 may be a portion of a camera (not shown) allowing direct inspection of the data contained on the diffraction grating-based optical identification element 105.

With continued reference to FIG. 2, the incoming laser beam 201A has a given wavelength, λ, at a given angle of incidence θᵢ. Any other input wavelength λ can be used as long as the wavelength is within an optical transmission range of the protective top layer 111. Depending upon whether the specialized diffracted light viewer 200 is designed to be used in transmission or reflection mode will determine whether the optical substrate 107 should be optically transparent for a given wavelength and angle of incidence.

While prior art identification cards having optically-embedded information have been produced and used successfully for many years, such cards tend to be expensive to manufacture and impossible to update since they rely upon photolithographically-produced diffraction elements containing user data. Manufacturing identification regions photolithographically is a time-consuming and expensive process requiring sophisticated fabrication facilities, expensive equipment, and caustic, dangerous chemicals. Therefore, what is needed is a safe and efficient system to produce an optically-based data storage region on an identification card. The card must be extremely difficult to copy while being easy for an end-user to read with a relatively inexpensive device. Ideally, the optically based data storage region will be incapable of being read either by a casual observer or surreptitiously without specialized equipment.

### SUMMARY OF THE INVENTION

In an exemplary embodiment, an optical media card forming at least a portion of an identification card is disclosed comprising an optical identification element formed upon a surface of the identification card and an optical stripe formed on the optical identification element having at least a portion formed substantially from a single material. The single material is configured to have a diffractive pattern formed thereupon by exposure to a laser. The diffractive pattern is capable of retaining information related to a cardholder and being readable by a light source external to the identification card.

In another exemplary embodiment, a method of producing a diffractive pattern on an optical element is disclosed. The method comprises compiling data for an identification card, calculating a far-field diffraction pattern containing the data, and calculating the diffractive pattern that is substantially equivalent to the far-field diffraction pattern.

In another exemplary embodiment, a processor-readable storage medium storing an instruction is disclosed. The processor-readable storage medium, when executed by a processor, causes the processor to perform a method for performing a diffraction pattern writing routine onto an optical element. The method comprises compiling data for an identification card, calculating a far-field diffraction pattern containing the data, and calculating the diffractive pattern that is substantially equivalent to the far-field diffraction pattern.

### BRIEF DESCRIPTION OF THE DRAWINGS

Various ones of the appended drawings merely illustrate exemplary embodiments of the present invention and must not be considered as limiting its scope.

FIG. 1 is a top perspective view with cross-sectional detail of an identification card of the prior art having an optical stripe containing data.

FIG. 2 is an optical diagram of a diffracted light viewer of the prior art used to read optically embedded data from an identification card such as the prior art identification card of FIG. 1.

FIG. 3 is a top perspective view with detail of an exemplary embodiment of an identification card containing an optical stripe in accordance with aspects of the present invention.

FIG. 4 is a simplified cross-sectional exemplary overview of light incident on the optical stripe of the identification card of FIG. 3.

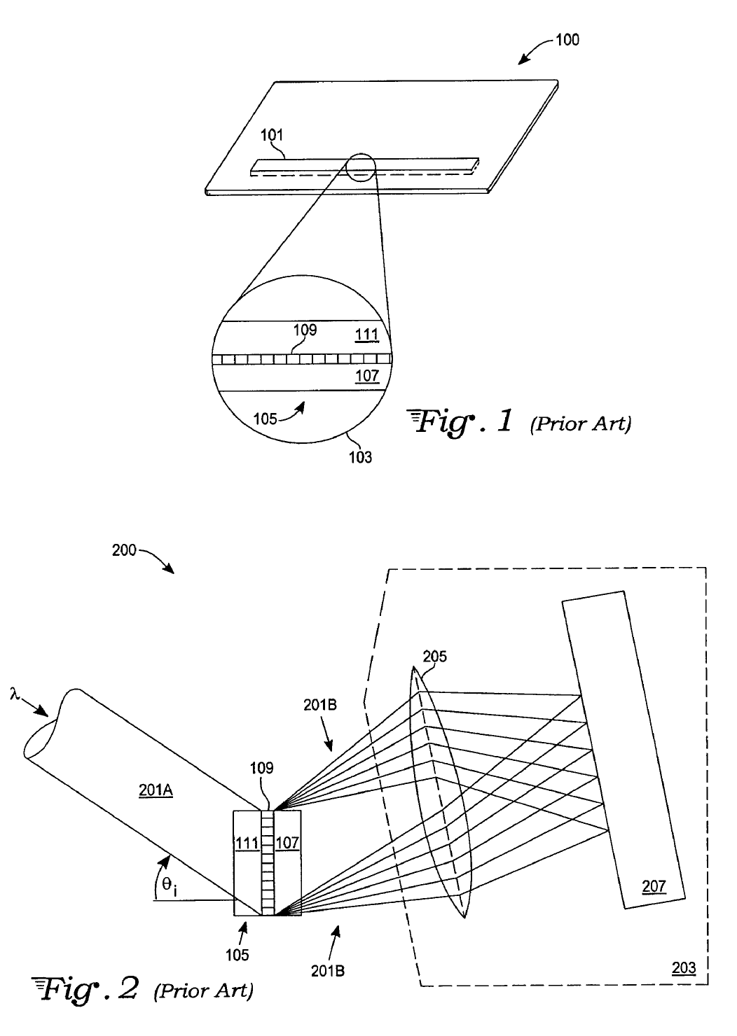

### DETAILED DESCRIPTION

As indicated above, a person of skill in the art recognizes that data and identification cards can be made more secure by utilizing an optical stripe on the card containing diffraction patterns produced by photolithography. Various embodiments of the present invention contemplate producing data cards using unique diffraction patterns produced by a laser using a holographic writing process. The diffraction pattern produced by the laser can be read either in transmission or reflection. No photolithography is required. In an exemplary embodiment, the diffraction pattern is not visible by a simple non-aided visual inspection of the card.

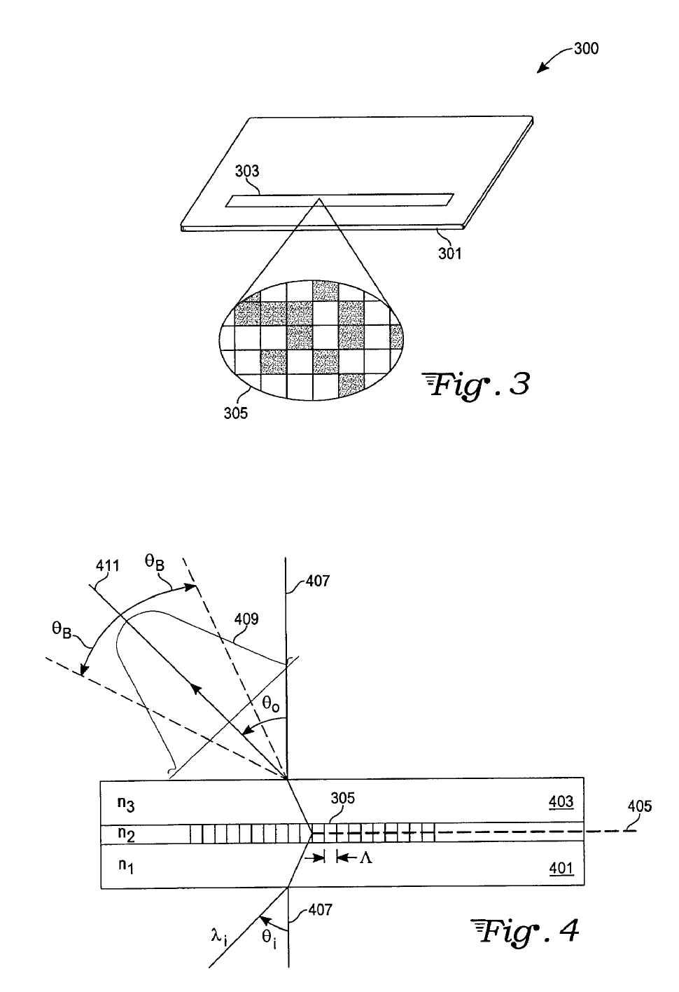

With reference to FIG. 3, an exemplary embodiment of an identification card 300 includes a substrate 301 and an optical stripe 303. In a specific exemplary embodiment, the optical stripe 303 is written with an optical head containing a laser (not shown). Optical heads for driving or scanning lasers in a plurality of directions with multiple degrees of freedom are known independently in the art.

The optical stripe 303 may be comprised of, for example, a laser recording material such as Drexon®. Drexon® is made up of micrometer-sized silver particles in a gelatin matrix and having known optical reflectivity at various wavelengths. Drexon® is manufactured by LaserCard Corporation, 1875 N. Shoreline Blvd., Mountain View, Calif., USA.

The laser used to write the optical stripe 303 may be, for example, a 780 nm wavelength solid state laser. Additionally, various other types and wavelengths of lasers, could be used as well. The laser writes a diffractive pattern 305 to the Drexon® media or any other media used to fabricate the optical stripe 303. The diffractive pattern 305 may be one-dimensional (not shown) in that it varies in only one axis (for example, along a long axis of the identification card 300). Alternatively, as shown in FIG. 3, the diffractive pattern 305 may be two-dimensional in that the pattern varies both parallel to and normal to the long axis of the identification card 300. The two-dimensional pattern may be best utilized where a viewer, such as the diffracted light viewer 200 of FIG. 2, is capable of scanning in two or more directions. Such scanning techniques are known independently in the art.

In another embodiment (not shown), the diffractive pattern on the identification card 300 may be based on a patterned radial variation or some combination of Cartesian (e.g., one- or two-dimensional patterns) and radial variations.

No matter the actual pattern produced, the diffractive pattern 305 is typically written by a laser or other coherent light source using a standard process of darkening (i.e., making an area of the final pattern non-reflective) a portion of a reflective material. Such processes are described in, for example, U.S. Patent No. to Richard M. Haddock, entitled “Method of Making Secure Personal Data Card,” which is commonly assigned to the assignee of the present invention and is hereby incorporated by reference in its entirety. Additionally, U.S. Pat. Nos. 4,680,459; 4,814,594; and 5,421,619, also assigned to the assignee of the present invention and hereby incorporated by reference, describe the creation of laser recorded data in optical memory cards.

In a specific exemplary embodiment, a holographic writing process is used whereby two or more light beams (e.g., from a single laser in a system employing a beam splitter or, alternatively, a plurality of lasers) interfere with one another on a path to the reflective material resulting in interference patterns being written.

In another specific exemplary embodiment, the diffractive pattern is established with a computer program causing the interference pattern to form in a particular way. The diffractive pattern is then converted either to a bitmap or vector pattern and a laser is instructed to write the pattern to a data storage medium to be viewed by a diffractive viewer. In this embodiment, the holographic process is thus simulated by a computer program which creates a bitmap or vector pattern that is written to the identification card 300 by darkening certain areas of the optical stripe 303 using a laser. A resulting diffractive pattern on the optical stripe 303 would not be visible on the identification card 300 without the use of an optical aid. The interference pattern would only be visible using an optical enhancement device such as, for example, a microscope. Even then, the diffractive pattern would be meaningless without a correct interpretive algorithm applied.

In a specific exemplary embodiment, the diffractive pattern 305 is computed using a computer program that estimates a correct diffractive (i.e., input) pattern, calculates a corresponding output pattern, and then compares the resulting output patterns against a desired output pattern. The program keeps changing the diffractive pattern iteratively, keeping those changes that tend to produce a result that is closer to the desired output pattern. These changes are repeated until the output pattern is of sufficient quality (i.e., substantially equivalent to the desired pattern) to satisfy the need for the pattern to be identified. The software thus creates a diffractive pattern that instead of being recognized by people as a certain pattern, is recognized only by a specialized reader, described herein, as an encoded serial number. Two-dimensional bar codes and “micro-spot” technologies are independently known ways of encoding digital data (bits) onto an optical image. The image formed from the diffractive pattern 305 onto a CCD array of the reader contains light and dark areas that comprise the patterns.

A modified version of the diffracted light viewer 200 may be utilized to read the identification card 300 in which the optional biconvex collection lens element 205 is unnecessary since an output light pattern coming from the identification card 300 is spreading out. Thus, a resulting image becomes larger at increasing distances from the CCD detection element 207 to the identification card 300. Consequently, if the CCD detection element 207 is a certain distance from the identification card 300, the optional biconvex collection lens element 205 is unnecessary.

A normal reading/writing optical setup for typical optical memory cards of the prior art utilizes sharp angles for the light and therefore a very narrow depth-of-field. The narrow depth-of-field is required in order to maximize the size of the beam as it goes through the surface of a protective layer of a card. Maximizing the beam diameter allows optical setup to focus past any dirt or scratches on the surface layer. For example, a diameter of the spot on which the laser beam is focused may be 2.5 micrometers (μm), while the diameter of the area through which the beam passes on the surface of the card may be 2000 μm (i.e., 2 mm).

Using the holographic process defined herein allows information on the identification card 300 to spread out, instead of merely spreading out the light as it passes the surface of the card. Thus, the viewing system can “look past” most dirt or scratches without tightly focusing the beam of light. Not having to tightly focus the light makes the reader for the hologram much less expensive than it might otherwise be since no complex optical trains are required.

Thus, the identification card 300 may be read in a manner similar to how most short-range RFID cards are read today: by placing them in proximity to an inexpensive reader. However, the identification card 300 cannot be read unless the diffractive pattern 305 on the optical stripe 303 is exposed to an illuminating laser of the reader. Such a card cannot readily be read surreptitiously as can an RFID card.

Thus, specific embodiments of the present invention employ a system that replaces an RFID card with an optical card that has advantages of an RFID card (e.g., an inexpensive reader, easy to scan) without accompanying disadvantages (e.g., susceptibility to electromagnetic fields, susceptibility to bending, and surreptitious reading). Prior art diffractive patterns on optical cards authenticate a type of card (using an image common to all cards of a given type) but cannot identify an individual card. Moreover, prior art optical cards are serialized using well-known techniques, but require a serial number reader that is relatively large and expensive.

A diffractive serial number may be used as a replacement for a traditional RFID card. Alternatively, the optical stripe 303 with the diffractive pattern 305 may be used as a supplement to the traditional RFID card thus allowing certain data types to be encoded as RFID while the diffractive pattern 305 can carry more sensitive data. Since the diffractive pattern 305 produces a diffracted light pattern only discernible by a given system, a resulting embedded serial number (or any other types of embedded data) could not be surreptitiously read or cloned.

A portion of the diffractive data storage reading system may consist of an optical diffractive viewer, currently available from LaserCard Corporation (Mountain View, Calif., USA). The viewer is a semiconductor laser that illuminates the medium (i.e., the optical stripe 303) coupled with a CCD detector. The viewer could be used to produce, for example, serial numbers for RFID or similar cards, where the serial numbers are written and read in diffraction. Such serial numbers help authenticate the cards.

For example, one LaserCard Corporation diffractive viewer has no lenses. Only an inexpensive off-the-shelf solid-state 632.8 nm laser and a mirror are used to image a pattern from the diffractive pattern 305 onto a small screen (not shown) of approximately 1 cm in diameter. A skilled artisan will recognize that other types and wavelengths of reading lasers may be readily employed as well. A pattern corresponding to a serial number is written into the diffractive pattern 305. The reader then replaces the small screen with a CCD array coupled to digital circuitry that interprets the pattern thus converting the pattern to a unique serial number. The reader might also have a lens, but the system will have a large depth of field, so a position of the lens, if used, will not be critical.

As an overview of a reading process of the diffractive pattern 305, reference is now made to a simplified exemplary process overview of FIG. 4, which includes a cross-section of the optical stripe 303 with a monochromatic incident beam at wavelength λᵢ at an angle-of-incidence of θᵢ. The optical stripe 303 includes the diffractive pattern 305, an optical substrate 401, and a top protective layer 403.

In a specific alternative exemplary embodiment, the diffractive pattern 305 may not be surrounded by the optical substrate 401 or the top protective layer 403. In this embodiment, the diffractive pattern may be interrogated by a laser directly in either a transmissive mode or a reflective mode (not shown) based upon a material selected on which the diffractive pattern 305 is produced.

With continued reference to FIG. 4, to read the diffractive pattern 305 from the optical stripe 303, the incident beam must be reflected, diffracted, or scattered by the diffractive pattern 305. As is known to one of skill in the art, at least two conditions must be met for light to be reflected. First, a diffraction condition for the diffractive pattern 305 must be satisfied. This condition, as is known, is the diffraction (or reflection or scatter) relationship between the incident wavelength λᵢ, the input incidence angle θᵢ, an output incidence angle θₒ, and a spatial period Λ of the diffractive pattern 305. The governing equation is given as:

$$sin ( {θ}_{i} ) + sin ( {θ}_{o} ) = \frac{m λ}{{n}_{y} Λ}$$

where m is the diffractive order being observed, n_{y} is the refractive index of a material through which incident and diffractive beams pass (e.g., n₁ is the refractive index of the optical substrate 401), and θₒ is an output angle of the diffracted beam (measured from an angle normal to a surface as indicated by a normal line 407). The spatial wavelength, Λ, of the diffractive pattern 305 is merely the inverse of the spatial frequency of the diffractive pattern, f. Thus,

$$f = \frac{1}{Λ} .$$

The governing equation given above therefore provides a relationship between an incident beam and resulting diffracted beams.

As a result, for a given input wavelength λᵢ, spatial wavelength Λ, and angle of incidence θᵢ, the output incidence angle θₒ, may be readily determined. Rearranging the governing equation above to solve for θₒ and using m=1 for the first diffracted order, results in:

$${θ}_{o} = {sin}^{- 1} ( \frac{λ}{Λ - sin ( {θ}_{i} )} )$$

The second condition for reading diffracted or scattered light is that the diffracted angle of the output beam θₒ must lie within an acceptable region of a Bragg envelope 409 to provide an acceptable intensity level of output light. The Bragg envelope 409 defines the diffracted or scattered efficiency of incident light. The Bragg envelope 409 has a center (or peak) on a center line 411 where refection efficiency is greatest when θᵢ=θₒ. The Bragg envelope has a half-width θ_{B} from the center line 411 or a total width of 2θ_{B}. For enhanced efficiency in light output, the diffracted angle of the output beam θₒ should be at the center of the Bragg envelope 409.

Thus, any code embedded into the diffractive pattern 305 of the optical stripe 303 may be readily discerned if all of the parameters given are known to devise a proper identification card reader. A skilled artisan would be able to extend the simplified parameters given above into designing a card reader capable of reading two-dimensional cards as defined herein.

In the foregoing specification, the present invention has been described with reference to specific embodiments thereof. It will, however, be evident to a skilled artisan that various modifications and changes can be made thereto without departing from the broader spirit and scope of the present invention as set forth in the appended claims. For example, all embodiments described utilize a monochromatic light source in the form of a laser. However, a skilled artisan will recognize that other light sources, or combinations of sources, even at varying angles of incidence and polarization states, may be used as well. For instance, broadband sources with appropriate bandpass filters or monochromators may be used to form a diffractive pattern on the optical stripe. Further, other high-powered sources of electromagnetic radiation may also be adapted to form the diffractive pattern. Additionally, various combinations of embodiments described herein may be employed and both optical, magnetic, and other RFID structures may all be combined into a single identification card. Therefore, these and various other embodiments are all within a scope of the present invention. The specification and drawings are, accordingly, to be regarded in an illustrative rather than a restrictive sense.

What is claimed is:

1. An optical media card used to form at least a portion of an identification card, the optical media card comprising:
an optical identification element formed upon a surface of the identification card;
an optical stripe formed on the optical identification element having at least a portion formed substantially from a single material, the single material configured to have a diffractive pattern formed thereupon by exposure to a laser, the diffractive pattern capable of retaining information related to a cardholder and being readable by a light source external to the identification card.

2. The optical media card of claim 1 further comprising an optical substrate formed on a first face of the optical stripe and an optically transparent protective layer formed on a second face of the optical stripe.

3. The optical media card of claim 1 wherein the diffractive pattern is formed on the optical stripe in one-dimension.

4. The optical media card of claim 1 wherein the diffractive pattern is formed on the optical stripe in two-dimensions.

5. The optical media card of claim 1 wherein the diffractive pattern is formed radially outward upon and from a center point of the optical stripe in two-dimensions.

6. The optical media card of claim 1 further comprising an electronic memory formed on the surface of the identification card.

7. The optical media card of claim 1 wherein the diffractive pattern is formed in a bitmapped fashion.

8. The optical media card of claim 1 wherein the diffractive pattern is formed in a vector fashion.

9. A method of producing a diffractive pattern on an optical element, the method comprising:
compiling data for an identification card;
calculating a far-field diffraction pattern containing the data; and
calculating the diffractive pattern that is substantially equivalent to the far-field diffraction pattern.

10. The method of claim 9 further comprising writing the diffractive pattern directly onto the optical element through a light source without requiring photolithography.

11. The method of claim 10 wherein the light source is selected to be a laser.

12. The method of claim 10 wherein the light source is selected to be broadband source.

13. The method of claim 9 wherein the diffractive pattern is written in one-dimension.

14. The method of claim 9 wherein the diffractive pattern is written in two-dimensions.

15. The method of claim 9 wherein the diffractive pattern is written radially.

16. The method of claim 9 wherein the step of calculating the diffractive pattern that is substantially equivalent to the far-field diffraction pattern includes calculating an equivalent bitmapped diffractive pattern.

17. The method of claim 9 wherein the step of calculating the diffractive pattern that is substantially equivalent to the far-field diffraction pattern includes calculating an equivalent vectorized diffractive pattern.

18. A processor-readable storage medium storing an instruction that, when executed by a single processor, causes the processor to perform a method for performing a diffraction pattern writing routine onto an optical element, the method comprising:
compiling data for an identification card;
calculating a far-field diffraction pattern containing the data; and
calculating a diffractive pattern that is substantially equivalent to the far-field diffraction pattern.

19. The processor-readable storage medium of claim 18 further comprising producing the diffractive pattern directly onto the optical element through a light source without requiring photolithography.

20. The processor-readable storage medium of claim 19 wherein the light source is selected to be a laser.

21. The processor-readable storage medium of claim 19 wherein the light source is selected to be broadband source.

22. The processor-readable storage medium of claim 18 wherein the diffractive pattern is written in one-dimension.

23. The processor-readable storage medium of claim 18 wherein the diffractive pattern is written in two-dimensions.

24. The processor-readable storage medium of claim 18 wherein the diffractive pattern is written radially.

25. The method of claim 18 wherein the step of calculating the diffractive pattern that is substantially equivalent to the far-field diffraction pattern includes calculating an equivalent bitmapped diffractive pattern.

26. The method of claim 18 wherein the step of calculating the diffractive pattern that is substantially equivalent to the far-field diffraction pattern includes calculating an equivalent vectorized diffractive pattern.
